(19) United States
(12) Patent Application Publication
(10) Pub. No.: US 2012/0016577 A1
(43) Pub. Date: Jan. 19, 2012

(54) METHOD AND SYSTEM FOR DETERMINING INTEREST CONTENTS BASED ON TRAVEL ROUTE INFORMATION

(75) Inventors: Kyoung Wook KIM, Seongnam-si (KR); Ji Hye PARK, Seongnam-si (KR)

(73) Assignee: NHN CORPORATION, Seongnam-si (KR)

(21) Appl. No.: 13/182,735

(22) Filed: Jul. 14, 2011

(30) Foreign Application Priority Data
Jul. 14, 2010 (KR) 10-2010-0067862

(51) Int. Cl. G01C 21/00

(52) U.S. Cl. 701/201

(57) ABSTRACT

Provided is a method and system for determining interest content that may provide an actual travel route of a terminal. The method and system for determining interest content may search for a travel route from a terminal to an interest content point based on location information of the terminal and location information of the interest content, may generate an interest content list including interest contents according to the found travel route, and may display the generated interest content list.

### CROSS-REFERENCE TO RELATED APPLICATION

This application claims priority from and the benefit of Korean Patent Application No. 10-2010-0067862, filed on Jul. 14, 2010, which is hereby incorporated by reference for all purposes as if fully set forth herein.

### BACKGROUND OF THE INVENTION

1. Field of the Invention

Exemplary embodiments of the present invention relate to a method and system for determining interest content using a travel route of a user, and more particularly, to a method and system for determining suitable interest content to be displayed for a user based on a travel route of the user.

### DISCUSSION OF THE BACKGROUND

Currently, various portal sites provide a large amount of information associated with a keyword that is input from a user. For example, when the user inputs a restaurant of a predetermined region as a keyword using a terminal such as a personal computer (PC) and the like, a portal site may display restaurant information of the predetermined region on the terminal.

In particular, in response to an increasing demand from users, various portal sites may display, on a map, a location of a destination, for example, a restaurant selected by the user. In this example, a conventional portal site may provide a simple distance obtained by connecting, using a straight line, a point of departure selected by the user and a destination selected by the user.

However, in many cases, obstacles, for example, mountains, rivers, buildings, traffic lights, pedestrian overpasses, underground passes, and the like, may be present between the point of departure and the destination. Therefore, it may be difficult to move straight from the point of departure to the destination. Many errors may exist between a travel distance provided from a portal site and an actual travel distance and thus, many users may leave for the destination by applying an error time to the travel distance provided from the portal site. In this example, the users may arrive at the destination too early or too late. That is, the users may inefficiently use time. Here, the travel distance indicates a distance from the point of departure selected by the user to the destination.

Accordingly, there is a desire for a method that may provide a more accurate travel distance from a point of departure to a destination, thereby decreasing an error time according to a travel distance.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide a method and system for determining interest content that may provide an actual travel route from a point of departure to a destination, thereby decreasing an error time according to a travel route.

Exemplary embodiments of the present invention also provide a method and system for determining interest content that may provide a travel distance and a travel time based on a travel mode used from a point of departure to a destination, thereby enabling a user to efficiently use time.

Exemplary embodiments of the present invention also provide a method and system for determining interest content that may search for a travel route in real time and thereby provide in real time an interest content list including interest contents adjacent to the travel route.

Exemplary embodiments of the present invention also provide a method and system for determining interest content that may automatically connect a terminal to interest content that is selected from interest contents included in an interest content list.

Additional features of the invention will be set forth in the description which follows, and in part will be apparent from the description, or may be learned by practice of the invention.

An exemplary embodiment of the present invention discloses a method of determining interest content. The method includes searching for a travel route from a terminal to an interest content point based on location information of the terminal and location information of the interest content, generating an interest content list based on the found travel route, and displaying the generated interest content list on the terminal.

Another exemplary embodiment of the present invention discloses a system for determining interest content. The system includes a travel route search unit to search for a travel route from a terminal to an interest content point based on location information of the terminal and location information of the interest content, an interest content list generator to generating an interest content list based on the found travel route, and a content display unit to display the generated interest content list on the terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of a system for determining interest content according to an exemplary embodiment of the present invention.

FIG. 2 is a block diagram illustrating a detailed configuration of a system for determining interest content according to an exemplary embodiment of the present invention.

FIG. 3 is a block diagram illustrating a configuration of a travel route search unit of FIG. 2 according to an exemplary embodiment of the present invention.

FIG. 4 is a flowchart provided to describe an operation of a system for determining interest content according to an exemplary embodiment of the present invention.

FIG. 5 is a flowchart provided to describe a configuration of providing a travel route with neighboring interest contents extracted based on a keyword according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element or layer is referred to as being “directly connected to” another element, there are no intervening elements present. It will be understood that for the purposes of this disclosure, “at least one of” will be interpreted to mean any combination of the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XYY, XZ, YZ).

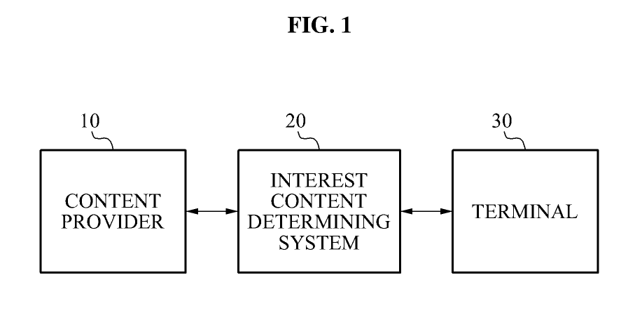

FIG. 1 is a block diagram illustrating a configuration of a system 20 for determining interest content according to an exemplary embodiment of the present invention.

Referring to FIG. 1, the interest content determining system 20 may collect content information from at least one content provider, for example, a content provider 10. For example, interest content may include an advertisement and the content provider 10 may include an advertiser. In this example, the content information may be directly input into the interest content determining system 20 by the content provider 10. The interest content determining system 20 may collect and database the content information that is input from the content provider 10. The interest content determining system 20 may store the databased content information in a content database (not shown) and thereby manage the content information. The content database may be stored on a non-transitory computer readable memory such as a hard disk drive, a flash memory, etc.

Here, the content information may include interest content location information and interest content side information. The interest content location information may include an address of the interest content, an Internet protocol (IP) address of a terminal, a Global Positioning system (GPS) information, latitude and longitude coordinates, a postal code, a telephone number, a regional code, and the like. The interest content side information may include a shop name of the interest content, a location thereof, an image thereof, a user opinion thereof, user ratings thereof, and the like.

Also, the interest content determining system 20 may receive location information of a terminal 30 from the terminal 30. For example, the interest content determining system 20 may receive location information, for example, an IP address of the terminal 30, GPS information of the terminal 30, and the like, and thereby obtain a location of the terminal 30. In this example, the terminal 30 may include a desktop computer, a notebook computer, an Internet television (TV), a navigation device, a smart phone, iPhone®, and the like.

When the terminal 30 corresponds to a terminal not having the IP address, the terminal 30 may transmit, to the interest content determining system 20, location information of the terminal 30 that is obtained using one of a GPS module, a Wireless-Fidelity Positioning System (WPS), and a cell-tower. When the terminal 30 corresponds to a terminal having the IP address, such as a notebook and a desktop computer, the terminal 30 may transmit the IP address of the terminal 30 to the interest content determining system 20 as location information of the terminal 30.

In addition, the terminal 30 may obtain a location of the terminal 30 based on location information of neighboring terminals adjacent to the terminal 30 by, for example, a single hop and the like, and may transmit the obtained location information of the terminal 30 to the interest content determining system 20. In this example, a neighboring terminal may refer to a terminal that is positioned within a distance communicable with the terminal 30 using a wireless local area communication scheme, such as a Bluetooth® module and the like.

The interest content determining system 20 may determine the location of the terminal 30 based on the received location information of the terminal 30. The interest content determining system 20 may search for a travel route of the terminal 30 by referring to the determined location of the terminal 30 and the content database, generate an interest content list based on the found travel route, and provide the generated interest content list to the terminal 30.

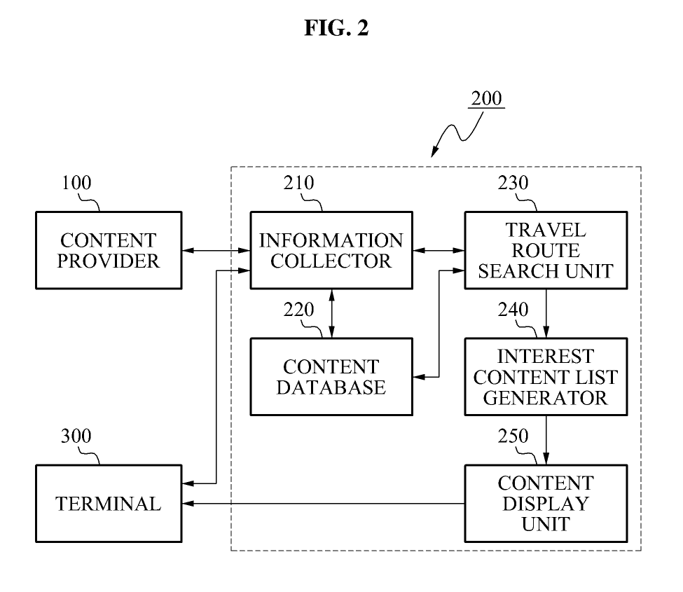

Hereinafter, a process of an interest content determining system to search for a travel route of a terminal and provide an interest content list according to the travel route will be described with reference to FIG. 2.

FIG. 2 is a block diagram illustrating a detailed configuration of a system 200 for determining interest content according to an exemplary embodiment of the present invention.

Referring to FIG. 2, the interest content determining system 200 may include an information collector 210, a content database 220, a travel route search unit 230, an interest content list generator 240, and a content display unit 250.

The information collector 210 may collect and database content information of interest contents provided by a content provider 100. For example, the information collector 210 may request content information of interest contents from the content provider 100. Also, for example, the content provider 100 may push content information of interest contents to the information collector 210. Databased content information may be stored in the content database 220 and thereby be managed. The content information may include interest content location information and interest content side information, and may be directly input from the content provider 100. Here, the interest content location information may include an address of interest content, an IP address of a terminal, a GPS information, latitude and longitude coordinates, a postal code, a telephone number, a regional code, and the like. The interest content side information may include a shop name of the interest content, a location thereof, an image thereof, a user opinion thereof, user ratings thereof, and the like.

Also, the information collector 210 may receive location information of a terminal 300 from the terminal 300. The location information of the terminal 300 may include at least one of an IP address of the terminal 300 and GPS information thereof. For example, when the terminal 300 includes a GPS module and has the IP address, the terminal 300 may transmit, to the information collector 210, all of the IP address and the GPS information of the terminal 300 that is obtained using the GPS module. When the terminal 300 includes only one of the IP address and the GPS information, the terminal 300 may transmit, to the information collector 210, one of the IP address and the GPS information that is included in the terminal 300.

The travel route search unit 230 may determine a location of the terminal 300 based on location information of the terminal 300. For example, the travel route search unit 230 may determine a geographical location of the terminal 300 based on the IP address or the GPS information of the terminal 300.

The travel route search unit 230 may search for the travel route of the terminal 300 by referring to the determined location of the terminal 300 and the content database 220. The travel route may include a travel distance and a travel time. For example, the travel route search unit 230 may search for travel routes from the terminal 300 to interest content points based on the location of the terminal 300 and location information of interest contents that are stored in the content database 220.

In this example, the travel route search unit 230 may search for an actual travel route from the terminal 300 to an interest content point for each travel mode, based on an obstacle present between the terminal 300 and the interest content point. Here, the travel mode may include at least one of a walk, a bicycle, a car, a motorcycle, an airplane, a boat, a public transportation, such as a bus, subway, trolley, airplane, ferry, etc. and the like.

For example, when the terminal 300 needs to make a detour due to an obstacle, such as a building, a pedestrian overpass, and the like, between the terminal 300 and the interest content point, the travel route search unit 230 may calculate a travel distance including a distance used to make a detour due to the obstacle. The travel route search unit 230 may calculate an actual travel distance from the terminal 300 to the interest content point for each travel mode. Similarly, for each travel mode, the travel route search unit 230 may calculate a travel time including a time used to make a detour due to the obstacle. In addition, the travel route search unit 230 may search for the travel route from the terminal 300 to the interest content for each travel mode, based on a weather environment such as snow, rain, wind, and the like, a traffic environment, a traffic light, a road environment such as a road repair, a road improvement, an uphill road, a downhill road, etc., and the like.

When a plurality of interest contents is stored in the content database 220, the travel route search unit 230 may search for travel routes from the terminal 300 to interest content points corresponding to the plurality of interest contents, for each travel mode. In this example, the interest content point may correspond to a point where interest content that the content provider 100 desires to inform is positioned and thus, may be a location at which a restaurant, a department store, a service place, and the like, is positioned. For example, the interest content point may be an advertisement point for advertising the interest content.

Also, the travel route search unit 230 may calculate the travel route from the terminal 300 to the interest content in real time for each travel mode. For example, when the terminal 300 moves, the travel route search unit 230 may calculate a location of the terminal 300 according to the movement of the terminal 300 in real time and search for the travel route from the terminal 300 to the interest content point in real time by referring to the calculated location of the terminal 300 and the content database 220.

The interest content list generator 240 may generate an interest content list based on the calculated travel route of the terminal 300. The interest content list generator 240 may generate the interest content list for each travel mode. For example, the interest content list generator 240 may sort interest contents in an ascending order of a travel time used from the location of the terminal 300 to the interest content point, for each travel mode. The interest content list generator 240 may generate the interest content list, including sorted interest contents, for each travel mode.

The content display unit 250 may display the generated interest content list on a website provided from the interest content determining system 200. The terminal 300 accessing the interest content determining system 200 may display the interest content list through a display of the terminal 300.

For example, the content display unit 250 may display, on a map, marks indicating interest contents included in the generated interest content list. The content display unit 250 may also display the calculated travel time and travel distance on the map.

The content display unit 250 may also display the interest content list based on a display range unit according to a travel mode that is input via the terminal 300. As one example, when the display range “1 km” and the travel mode “walk” is input after the interest content list is displayed, the content display unit 250 may display interest contents that are included within the coverage corresponding to 1 km on foot from the location of the terminal 300, among interest contents included in the interest content list. In this example, the content display unit 250 may also display travel times of the interest contents of which the travel distances is within 1 km on foot.

As another example, when the display range “ten minutes” and the travel mode “bus” is input, the content display unit 250 may display interest contents that are included within the coverage corresponding to ten minutes by bus from the location of the terminal 300, among the interest contents included in the interest content list. In this example, the content display unit 250 may also display travel distances of the interest contents of which the travel times is within ten minutes by bus.

The content display unit 250 may automatically connect the terminal 300 to interest content that is selected from the interest contents included in the displayed interest content list. For example, the content display unit 250 may automatically link the terminal 300 to a website of the selected interest content. Also, the content display unit 250 may provide a click-to-call phone connection using a telephone number of the selected interest content. Also, the content display unit 250 may display content information, for example, a shop name of the selected interest content, an address thereof, a telephone number thereof, a location thereof, a user opinion thereof, ratings thereof, and the like. In addition, the content display unit 250 may provide a discount coupon, event information, and printing and downloading of the discount coupon with respect to the selected interest content.

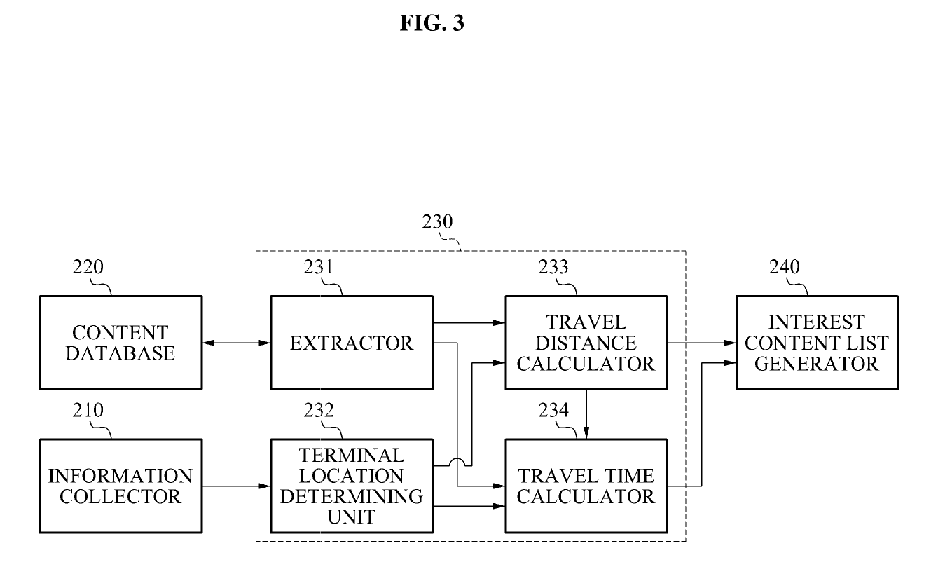

Searching travel routes from the location of the terminal 300 to interest content points of the interest contents stored in the content database 220 is described above with reference to FIG. 2. Hereinafter, searching a travel route using interest contents associated with an input keyword will be described with reference to FIG. 3.

FIG. 3 is a block diagram illustrating a configuration of the travel route search unit 230 of FIG. 2 according to an exemplary embodiment of the present invention.

Referring to FIG. 3, the travel route search unit 230 may include an extractor 231, a terminal location determining unit 232, a travel distance calculator 233, and a travel time calculator 234.

Using a regional code of a keyword input from the terminal 300, the extractor 231 may extract interest contents associated with the keyword from interest contents that are stored in the content database 220.

For example, when “restaurants around AAA station” is input as a keyword, the extractor 231 may extract interest contents, located in a place of a name belonging to “AAA station”, from the interest contents stored in the content database 220, based on a regional code corresponding to “AAA station” and location information of the interest contents stored in the content database 220.

The terminal location determining unit 232 may determine a location of the terminal 300 based on location information of the terminal 300 received from the information collector 210. For example, a geographical location of the terminal 300 may be determined using an IP address or GPS information of the terminal 300. The determined location of the terminal 300 may include geographical location coordinates of the terminal 300.

The travel distance calculator 233 may calculate a travel distance from the terminal 300 to interest content points of extracted interest contents, based on location information of the extracted interest contents and location information of the terminal 300. In this example, the travel distance calculator 233 may calculate an actual travel distance for each travel mode, based on obstacles between the terminal 300 and the interest content points of the extracted interest contents. In addition, the travel distance calculator 223 may calculate the travel distance for each travel mode, based on a weather environment such as snow, rain, wind, and the like, a traffic environment, a traffic light, a road environment such as an uphill road and a downhill road, and the like.

The travel time calculator 234 may calculate a travel time to reach the interest content points of the extracted interest contents from the terminal 300, based on location information of the extracted interest contents and location information of the terminal 300. In this example, the travel time calculator 234 may calculate the actual travel time for each travel mode based on obstacles between the terminal 300 and the interest content points of the extracted interest contents. The travel time calculator 234 may also calculate the travel time used to reach the interest content point from the terminal 300, for each travel mode, based on the weather environment, the traffic environment, the road environment, etc.

The interest content list generator 240 may sort the interest contents in an ascending order of at least one of the calculated travel distances and travel times, and may generate the interest content list including the sorted interest contents.

The content display unit 250 may display the generated interest content list via a website. The generated interest content list may be displayed on the display of the terminal 300 accessing the website.

In this example, the content display unit 250 may also display interest contents based on a display range unit according to a travel mode that is input from the terminal 300. Here, when the display range “1 km” and the travel mode “walk” is input, the content display unit 250 may extract interest contents of which travel distances is less than 1 km on foot, from interest contents included in the displayed interest content list, and may display the extracted interest contents. Also, when the display range “ten minutes” and the travel mode “car” is input, the content display unit 250 may extract interest contents of which travel times by car is less than about ten minutes, from interest contents included in the displayed interest content list and thereby display the extracted interest contents.

Also, the content display unit 250 may automatically connect the terminal 300 to the interest content selected by the terminal 300 from the interest contents included in the displayed interest content list. For example, the content display unit 250 may automatically link the terminal 300 to a website of the selected interest content and may also provide a click-to-call telephone connection. In addition, the content display unit 250 may display content information of the selected interest content, a discount coupon thereof, event information thereof, provide printing and downloading of the discount coupon, and the like.

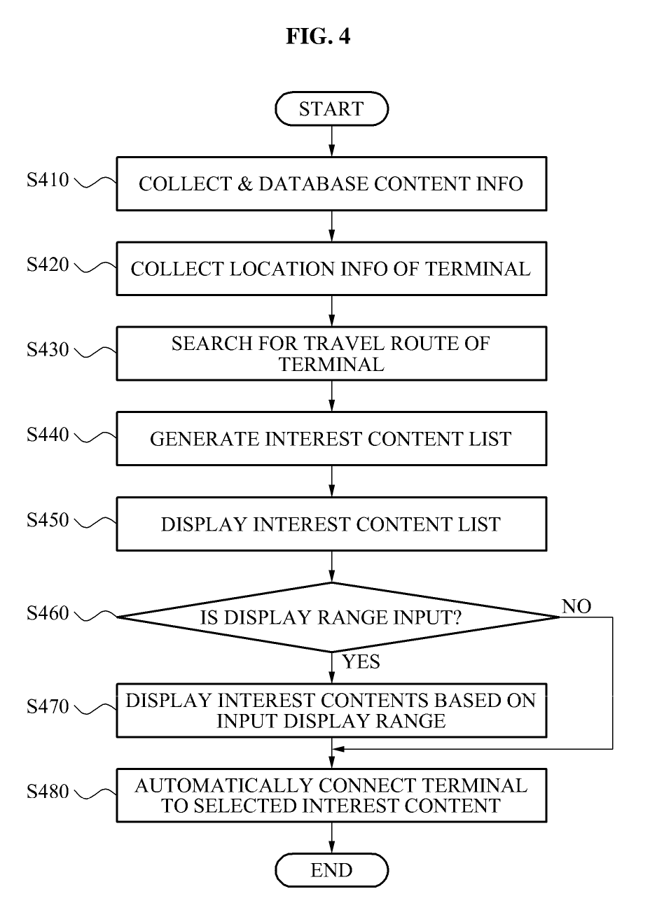

FIG. 4 is a flowchart provided to describe an operation of a system for determining interest content according to an exemplary embodiment of the present invention.

Referring to FIG. 2, in operation S410, the information collector 210 may collect and database content information of interest contents provided by the content provider 100. For example, the information collector 210 may request content information of interest contents from the content provider 100. Also, for example, the content provider 100 may push content information of interest contents to the information collector 210.

Databased content information may be stored in the content database 220 and thereby be managed. The content information may include interest content location information and interest content side information. The interest content location information may include an address of the interest content, an IP address of a terminal, a GPS information, latitude and longitude coordinates, a postal code, a telephone number, a regional code, and the like. The interest content side information may include a shop name of the interest content, a location thereof, an image thereof, a user opinion thereof, user ratings thereof, and the like.

In operation S420, the information collector 210 may collect location information of the terminal 300 from the terminal 300.

For example, location information of the terminal 300 may include an IP address and GPS information of the terminal 300. The travel route search unit 230 may determine a geographical location of the terminal 300 based on location information of the terminal 300.

In operation S430, the travel route search unit 230 may search for a travel route of the terminal 300 based on the determined location of the terminal 300 and location information of interest content. The travel route may include a travel distance and a travel time. That is, the travel route search unit 230 may search for the travel distance and the travel time of the terminal 300 for each travel mode.

In this example, the travel route search unit 230 may search for an actual travel route from the terminal 300 to an interest content point for each travel mode, based on obstacles present between the terminal 300 and the interest content point. Here, the travel mode may include at least one of a walk, a bicycle, a car, a motorcycle, a public transportation, and the like. In addition, the travel route search unit 230 may search for the actual travel route from the terminal 300 to the interest content point based on a traffic environment, a weather environment, a road environment, and the like.

In operation S440, the interest content list generator 240 may generate an interest content list based on the travel route found. The interest content list generator 240 may generate the interest content list in which interest contents are sorted for each travel mode.

As one example, the interest content list generator 240 may generate the interest content list in which the interest contents are sorted in an ascending order of calculated travel distances, for each travel mode. As another example, the interest content list generator 240 may generate the interest content list in which the interest contents are sorted in an ascending order of calculated travel times. As still another example, the interest content list generator 240 may generate the interest content list in which the interest contents are sorted in an ascending order of both the calculated travel distances and travel times.

In operation S450, the content display unit 250 may display the generated interest content list on a website. In this example, the content display unit 250 may display the interest content list based on a set basic travel mode.

As an example, when “walk” is set as the basic travel mode, the content display unit 250 may display the interest content list in which interest contents are sorted in an ascending order of travel distances calculated based on “walk”. In this example, the content display unit 250 may also display other travel mode selection items such as a “public transportation”, a “car”, a “bicycle”, a “motor bicycle”, and the like, to enable a user to select and change a travel mode.

When the display range and the travel mode is input in operation S460, the content display unit 250 may display interest contents based on the display range unit according to the travel mode in operation S470.

As one example, when the travel mode “walk” and the display range “1 km” is input, the content display unit 250 may extract interest contents of which travel distances is less than 1 km on foot, from interest contents included in the interest content list, and may display the extracted interest contents.

As another example, when the travel mode “bus” and the display range “ten minutes” is input, the content display unit 250 may extract interest contents of which travel times is less than ten minutes by bus, from the interest contents included in the interest content list, and may display the extracted interest contents.

In operation S480, the content display unit 250 may automatically connect the terminal 300 to interest content selected from the displayed interest contents.

For example, the content display unit 250 may automatically link the terminal 300 to a website of the selected interest content or may provide a click-to-call telephone connection. In addition, the content display unit 250 may display content information of the selected interest content, a discount coupon thereof, event information thereof, and provide printing and downloading of the discount coupon.

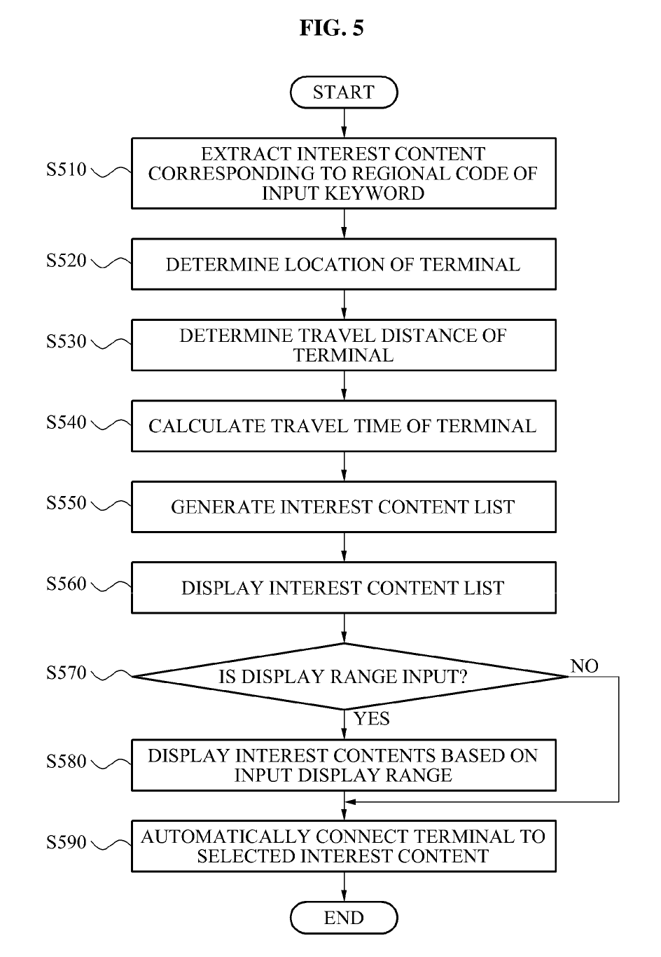

FIG. 5 is a flowchart provided to describe a configuration of providing a travel route with neighboring interest contents extracted based on a keyword according to an exemplary embodiment of the present invention.

Referring to FIG. 2, FIG. 3 and FIG. 5, in operation S510, the extractor 231 may extract interest content corresponding to a regional code of a keyword that is input via the terminal 300.

For example, the extractor 231 may extract interest contents associated with the keyword from interest contents stored in the content database 220 using the regional code of the input keyword. The extractor 231 may extract interest contents of which a region corresponding to location information matches the regional code of the keyword.

In operation S520, the terminal location determining unit 232 may determine the location of the terminal 300 based on location information of the terminal 300 that is received from the terminal 300.

For example, the terminal location determining unit 232 may determine a geographical location of the terminal 300 using an IP address or GPS information of the terminal 300. The location of the terminal 300 may include geographical location coordinates of the terminal 300.

In operation S530, the travel distance calculator 233 may calculate travel distances from the terminal 300 to interest content points of extracted interest contents, based on location information of the terminal 300 and location information of the extracted interest contents.

In operation S540, the travel time calculator 234 may calculate travel times used to reach the interest content points of the extracted interest contents from the terminal 300, based on location information of the terminal 300 and location information of the extracted interest contents.

In this example, the travel distance calculator 233 and the travel time calculator 234 may calculate an actual travel distance and an actual travel time for each travel mode, based on obstacles between the terminal 300 and the interest content points of the extracted interest contents. In addition, the travel distance calculator 233 and the travel time calculator 234 may calculate travel distances and travel times between the terminal 300 and the interest content points based on a weather environment, a traffic environment, a road environment, and the like.

In operations S550, S560, S570, S580 and S590, the interest content list generator 240 may generate an interest content list based on the calculated travel route and the content display unit 250 may display the generated interest content list. The travel route may include the travel distance and the travel time. A configuration of generating and displaying the interest content list is similar to operations S440 through S480 of FIG. 4 and thus, further detailed description related thereto will be omitted here.

Even though description is made based on an example in which the content database 220 is included in the interest content determining system 200, it is only an example. Therefore, the content database 220 may be present outside the interest content determining system 200. In this case, the content database 220 may be constructed by another system in addition to the interest content determining system 200.

According to exemplary embodiments of the present invention, it is possible to provide an actual travel route from a point of departure to a destination, thereby decreasing an error time according to a travel route.

According to exemplary embodiments of the present invention, it is possible to provide a travel distance and a travel time based on a travel mode used from a point of departure to a destination, thereby enabling a user to efficiently use time.

According to exemplary embodiments of the present invention, it is possible to search for a travel route in real time and thereby provide in real time an interest content list including interest contents adjacent to the travel route.

According to exemplary embodiments of the present invention, it is possible to automatically connect a terminal to interest content that is selected from interest contents included in an interest content list.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of determining interest content, the method comprising:
searching for a travel route from a terminal to an interest content point based on location information of the terminal and location information of the interest content;
generating an interest content list based on at least one found travel route; and
displaying the generated interest content list on the terminal.

2. The method of claim 1, wherein the searching comprises searching for the travel route based on location information of the terminal, location information of the interest content, and an obstacle present in the travel route from the terminal to the interest content point.

3. The method of claim 1, wherein the searching comprises searching for the travel route for each travel mode.

4. The method of claim 1, wherein the searching comprises:
extracting interest content corresponding to a regional code of a keyword based on location information of the interest content;
determining a location of the terminal based on location information of the terminal;
calculating a travel distance from the terminal to an interest content point of the extracted interest content based on the determined location of the terminal and location information of the extracted interest content; and
calculating a travel time from the terminal to the interest content point of the extracted interest content based on the determined location of the terminal and location information of the extracted interest content.

5. The method of claim 4, wherein generating the interest content list further comprises sorting interest contents in an ascending order of at least one of the travel distance and the travel time.

6. The method of claim 1, wherein the displaying comprises displaying interest contents of the generated interest content list, based on a display range unit that is input via the terminal.

7. The method of claim 1, further comprising:
connecting the terminal to user selected interest content selected from interest contents of the displayed interest content list.

8. The method of claim 1, further comprising:
displaying content information of user selected interest content selected from interest contents of the displayed interest content list.

9. The method of claim 1, wherein the displaying comprises displaying, on a map, marks expressing interest contents included in the interest content list.

10. A non-transitory computer-readable recording medium storing a program to implement the method of claim 1.

11. A system for determining interest content, the system comprising:
a travel route search unit to search for a travel route from a terminal to an interest content point based on location information of the terminal and location information of the interest content;
an interest content list generator to generate an interest content list based on at least one found travel route; and
a content display unit to display the generated interest content list on the terminal.

12. The system of claim 11, wherein the travel route search unit searches for the travel route based on location information of the terminal, location information of the interest content, and an obstacle present in the travel route from the terminal to the interest content point.

13. The system of claim 11, wherein the travel route search unit searches for the travel route for each travel mode.

14. The system of claim 11, wherein the travel route search unit comprises:
an extractor to extract interest content corresponding to a regional code of a keyword based on location information of the interest content;
a terminal location determining unit to determine a location of the terminal based on location information of the terminal;
a travel distance calculator to calculate a travel distance from the terminal to an interest content point of the extracted interest content based on the determined location of the terminal and location information of the extracted interest content; and
a travel time calculator to calculate a travel time from the terminal to the interest content point of the extracted interest content based on the determined location of the terminal and location information of the extracted interest content.

15. The system of claim 14, wherein the interest content list generator generates the interest content list of interest contents sorted in an ascending order of at least one of the travel distance and the travel time.

16. The system of claim 11, wherein the content display unit displays interest contents included in the generated interest content list, based on a display range unit that is input via the terminal.

17. The system of claim 11, wherein the content display unit connects the terminal to user selected interest content selected from interest contents included in the displayed interest content list.

18. The system of claim 11, wherein the content display unit displays content information of user selected interest content selected from interest contents included in the displayed interest content list.

19. The system of claim 11, wherein the content display unit displays, on a map, marks expressing interest contents included in the interest content list.
